(19) United States
(12) Patent Application Publication
(10) Pub. No.: US 2006/0172074 A1
(43) Pub. Date: Aug. 3, 2006

(54) Polyurea coating systems and related methods

(76) Inventor: Salvatore DiLoreto, Ancaster (CA)

Correspondence Address: PPG INDUSTRIES, INC.;Law Dept. - Intellectual Property, One PPG Place, Pittsburgh, PA, 15272, US

(21) Appl. No.: 11/050,268

(22) Filed: Feb. 3, 2005

(51) Int. Cl. B05D 7/00; B05D 3/02

(52) U.S. Cl. 427/421.1; 427/372.2

(57) ABSTRACT

There is disclosed a composition for forming a protective coating upon a substrate. The composition has been found particularly useful for forming a protective coating upon components of automotive vehicles, such as a bedliner for a pick-up truck. The composition may include, without limitation, an isocyanate component and an amine component and optionally includes one or more of a catalyst, stabilizer, pigment, fire retardant or other additives.

### BACKGROUND OF THE INVENTION

### Field of the Invention

The present invention relates to a polyurea composition useful for forming a protective coating on a substrate, particularly an automotive substrate and to a process for using the composition.

Historically, polyurea elastomer systems have been used as protective coatings for various substrates, both to protect the substrates and to improve the properties of the substrates. For example, and without limitation, polyurea coatings have been developed to protect substrates from various environmental conditions such as weathering and ultraviolet light degradation, as well as to provide abrasion and impact resistance properties to the coated substrates.

In the automotive industry, coatings are used to provide aesthetically pleasing glamour finishes to automobiles, as well as for protecting various components of an automotive vehicle against corrosion, light degradation, marring, denting and/or chipping from contact with road debris. Such coating compositions should be relatively easy to handle, and have relatively low volatile emissions upon application and curing. Thus, the present invention provides a composition for forming a coating with improved protection capabilities, ease of handling and relatively low volatile emissions.

### SUMMARY OF THE INVENTION

The present invention meets the above needs and others by providing a composition and process for coating a substrate. The process for coating a surface of an automotive vehicle comprises (a) providing a surface of an automotive vehicle; (b) contacting the surface with a composition comprising: (i) an isocyanate in an amount up to about 75% by volume of the composition, the isocyanate being at least 75% aliphatic by weight; and (ii) an amine in an amount up to about 75% by volume of the composition, the amine including between greater than 0% and about 40% by volume of an aliphatic primary amine and between about 40% and about 80% by volume of an aliphatic secondary amine; wherein the ratio of the isocyanate to the amine within the composition is between 1:3 and 3:1.

### DETAILED DESCRIPTION OF THE INVENTION

The present invention provides a process and composition for forming a protective coating upon a substrate. In one embodiment, the composition forms a protective coating on a substrate provided by one or more components of an automotive vehicle. In another embodiment, the composition forms a protective coating on a surface of a pick-up truck bed, and thus forms a bed-liner for such pick-up truck.

As mentioned above, the polyurea composition of the present invention includes at least the following two components: (1) an isocyanate component; and (2) an amine component.

The isocyanate component may include a single isocyanate or a mixture of two or more different isocyanates. Amounts of isocyanate present in the composition can range from up to about 80% by volume, or up to about 75% by volume, or between about 30% to about 70% by volume. the isocyanate also can be present in the composition in an amount ranging from about 40% to about 60% by volume, or from about 45% to about 55% by volume.

Isocyanates suitable for use in the polyurea compositions of the present invention may be monoisocyanates, diisocyanates, polyisocyanates or a combination thereof. Included in the definition of isocyanates are the isocyanates themselves, or optionally dimers, trimers, prepolymers or quasi-prepolymers thereof with active-hydrogen components (e.g., obtainable, for example, from use of a polyol, amine-terminated polyether, or otherwise).

Exemplary monoisocyanates include, without limitation, isophorone monoisocyanate, 3,5-dimethylphenyl isocyanate, paratoluenesulfonyl monoisocyanate.

Representative examples of diisocyanates include, without limitation, 4,4′-diisocyanatodiphenylmethane, p-phenylene diisocyanate, 1,3-bis(isocyanatomethyl)-cyclohexane, 1,4-diisocyanatocyclohexane, 1,5-naphthalene diisocyanate, 3,3′-dimethyl-4,4′-biphenyl diisocyanate, 4,4′-diisocyanatodicyclohexylmethane, and 2,4-toluene diisocyanate, or mixtures thereof. Other suitable examples include 4,4′-diisocyanatodicyclohexylmethane and 4,4′-diisocyanatodiphenylmethane, 4,4′-diisocyanatodiphenylmethane. Other potential isocyanates include, without limitation, triisocyanates such as toluene-2,4,6-triisocyanate and isocyanates such as 4,4′-dimethyldiphenylmethane-2,2′,5′5′-tetraisocyanate and the diverse polymethylene polyphenyl polyisocyanates.

Isocyanates of the present invention may be aromatic or aliphatic (e.g., cycloaliphatic). In an embodiment of the present invention, the major portion of the isocyanate composition is aliphatic. In one embodiment, at least 75% of the isocyanate can be aliphatic by weight, or at least 90% of the isocyanate is aliphatic by weight, or at least 99% of the isocyanate is aliphatic by weight.

In one embodiment, the isocyanate can have an NCO equivalent weight of at least about 130, or at least about 160, or at least about 200; and can be no greater than about 500, or no greater than about 400, or no greater than about 300. Moreover, It is desirable for the isocyanate to have a relatively low residual monomer level, i.e., typically less than about 1% by weight, or less than about 0.2% by weight, or less than about 0.05% by weight. Such low residual monomer level can assist in lowering volatile emission levels while handling the unreacted component or during application of the composition, as well as limiting toxicity of the isocyanate component.

In an embodiment of the present invention, the isocyanate includes a liquid aliphatic isocyanate oligomer or prepolymer based upon dicyclohexylmethane 4,4′-diisocyanate (H12 MDI), isophorone diisocyanate (IPDI), tetramethyl-1,3-xylylene diisocyanate (TMXDI), hexamethylene diisocyanate (HDI) or a mixture thereof. In one embodiement, the isocyanate compsrises a dimerized, trimerized or the biureted form of hexamethylene diisocyanate (HDI) or its quasi-prepolymer. An example of such a composition is DESMODUR XP-7100, commercially available from Bayer Corporation, Pittsburgh, Pa.

The amine present in the polyurea composition of the present invention is available for reaction with the isocyanate component to form a urea linkage(s). By “amine component” herein, it is meant a component having an amine functional group, such as molecules, compounds, oligomers, polymers, or the like having an amine termination or active hydrogens that are amine hydrogens. The amount of amine may be any suitable amount for achieving the desired amount of urea linkages. For instance, the amine may be present in the composition in an amount up to about 75% by volume, or from about 30% to about 70% by volume. In an embodiment of the invention, the amine can be present in the composition in an amount ranging from about 40% to about 60% by volume, or from about 45% to about 55% by volume.

Amines suitable for use in the composition of the present invention can include primary, secondary, tertiary amines, or mixtures thereof. The amines may by monoamines, diamines, triamines or mixtures thereof. The amines may be aromatic or aliphatic (e.g., cycloaliphatic), but typically aliphatic. In an embodiment of the present invention, the amine component comprises one or more primary amines, and one or more secondary amines. Also, if a mixture of primary and secondary amines is employed, the primary amine can be present in an amount up to about 60 parts by volume, or up to about 50 parts by volume, or between from greater than 0% and about 40% by volume, with the secondary amine present in an amount up to about 100 parts by volume.

In an embodiment of the present invention, suitable primary amines can have a molecular weight greater than about 200 (e.g., for reduced volatility), and suitable secondary amines present in the composition typically comprise diamines that can have molecular weights of at least about 190 (e.g., about 210-230).

In one embodiment, the amine component includes at least one secondary amine present in an amount of about 20% to about 100%, and can be present in an amount of about 40% to about 80%, or about 50% to 70% by volume. Suitable secondary amines can include mono-functional acrylate or methacrylate modified aliphatic polyamines. Examples of the aliphatic polyamines includes, without limitation, ethylamine, the isomeric propylamines, butylamines, pentylamines, hexylamines, cyclohexylamine, ethylene diamine, 1,2-diaminopropane, 1,4-diaminobutane, 1,3-diaminopentane, 1,6-diaminohexane, 2-methyl-1,5-pentane diamine, 2,5-diamino-2,5-dimethylhexane, 2,2,4- and/or 2,4,4-trimethyl-1,6-diamino-hexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotoluylene diamine, 2,4′- and/or 4,4′-diamino-dicyclohexyl methane and 3,3′-dialkyl4,4′-diamino-dicyclohexyl methanes (such as 3,3′-dimethyl-4,4′-diamino-dicyclohexyl methane and 3,3′-diethyl-4,4′-diamino-dicyclohexyl methane), 2,4- and/or 2,6-diaminotoluene and 2,4′-and/or 4,4′-diaminodiphenyl methane, or mixtures thereof.

An example of a suitable amine includes an aliphatic amine, such as a cycloaliphatic polyamine with high steric hindrance that is optionally modified with an n-butyl group. One such amine is available commercially from UOP under the designation of CLEARLINK™. Another suitable example of a primary amine is an acrylic modified primary amine.

In another embodiment of the present invention, the amine is provided as a secondary amine-functional resin which has a relatively low viscosity, and is suitable for use in the formulation of high solids polyurethane/polyurea coatings. One such secondary amine-functional resin is an ester of an organic acid. which is substantially free of solvent such as an aspartic ester-based amine-functional reactive resin that is compatible with isocyanates (e.g., one that is solvent free, and/or has a mole ratio of amine functionality to the ester of no more than 1:1 so there remains no excess primary amine upon reaction), e.g., DESMOPHEN NH 1220 commercially available from Bayer Corporation, Pittsburgh, Pa. Of course, other suitable compounds containing aspartate groups may be employed as well. Other examples of secondary polyamines include the polyaspartic esters, which are derivatives of compounds such as maleic acid, fumaric acid esters, aliphatic polyamines and the like.

Such compounds may be prepared in any suitable art-disclosed manner. By way of example, without limitation, the subject matter described in U.S. Pat. No. 5,126,170, 5,236,741 or both, hereby incorporated by reference, may be employed as guidance. For instance primary monoamines or polyamines may be reacted with substituted or unsubstituted maleic or fumaric acid esters.

Without limitation, examples of substituted or unsubstituted maleic or fumaric acid esters suitable for preparing the aspartic esters include dimethyl, diethyl and di-n-butyl esters of maleic acid and fumaric acid, mixtures of maleates and fumarates, and the corresponding maleic acid esters, fumaric acid esters, or mixtures thereof, substituted by methyl in the 2-position, 3-position or both.

Examples of suitable amines for preparing the aspartic esters include without limitation ethylamine, the isomeric propylamines, butylamines, pentylamines, hexylamines, cyclohexylamine, ethylene diamine, 1,2-diaminopropane, 1,4-diaminobutane, 1,3-diaminopentane, 1,6-diaminohexane, 2-methyl-1,5-pentane diamine, 2,5-diamino-2,5-dimethylhexane, 2,2,4- and/or 2,4,4-trimethyl-1,6-diamino-hexane, 1,11-diaminoundecane, 1,12-diaminododecane, 1,3- and/or 1,4-cyclohexane diamine, 1-amino-3,3,5-trimethyl-5-aminomethyl-cyclohexane, 2,4-and/or 2,6-hexahydrotoluylene diamine, 2,4′- and/or 4,4′-diamino-dicyclohexyl methane and 3,3′-dialkyl-4,4′-diamino-dicyclohexyl methanes (such as 3,3′-dimethyl-4,4′-diamino-dicyclohexyl methane and 3,3′-diethyl-4,4′-diamino-dicyclohexyl methane), 2,4- and/or 2,6-diaminotoluene and 2,4′- and/or 4,4′-diaminodiphenyl methane, or mixtures thereof.

One specific example of the polyaspartic esters is the derivative of diethyl maleate and 1,5-diamino-2-methylpentane, available commercially from Bayer Coporation, Pittsburgh, Pa. under the trade name DESMOPHEN NH1220.

Another group of suitable polyaspartic esters are derivatives of dialkyl maleate or furmarate and cycloaliphatic polyamines with the chemical structure of R—(CH2.—NH2)n where, n>/=2, and R represents an organic group which is inert towards isocyanate groups at a temperature of 100° C. or less, and contains at least one cycloaliphatic ring. An example, without limitation, is 1,3- or 1,4-bis-aminomethyl cyclohexane, or the mixture thereof.

The amine component may also include high molecular weight primary amines, such as polyoxyalkyleneamines at the amount of 0 to 50% by volume, or greater than 0% and up to 40% by volume, or 10% to 40% by volume, or 20% to 30% by volume. The polyoxyalkyleneamines contain two or more primary amino groups attached to a backbone, such as propylene oxide, ethylene oxide, or a mixture thereof. Examples of such amines include those offered under the designation JEFFAMINE™ from Huntsman Corporation, with a molecular weight ranging from about 200 to about 7500, such as, without limitation, JEFFAMINES D-230, D-400, D-2000, T-403 and T-5000.

Other suitable ingredients, such as isocyanates, amines or amine functional resins suitable for use in the present invention include those disclosed in U.S. Pat. Nos. 5,236,741; 5,243,012; 6,013,755; and 6,180,745, all of which are hereby incorporated by reference for all purposes.

It should be recognized that concentrates or diluted forms of the present composition may be employed, pursuant to which the proportion of the amine to isocyanate assumes a proportion corresponding with the above volume percentages. Thus, for example, in one embodiment, the amine and the isocyanate are present in an amount of about 1:10 to about 10:1 parts by volume, and more preferably about 1:3 to about 3:1 parts by volume, and still more preferably about 1:1 parts by volume. For example, a highly preferred proportion is about 1.3:1 parts by volume of amine to isocyanate.

In addition to amine and isocyanate, the composition may include one or more additional ingredients such as catalysts, light stabilizers, pigments, fire retardants or other performance or property modifiers. As described below, any such additives typically are provided as part of the amine component prior to combination with the isocyanate component. However, it is contemplated that various ingredients of the composition may be combined with the isocyanate prior to combining the remaining ingredients.

In one embodiment, the present composition employs no catalyst. However, in certain embodiments, it is possible that one or more art-disclosed catalysts may be provided in the composition as desired. Examples include conventional polyurethane catalysts, such as organometallic catalysts (e.g., stannous compounds).

One or more light stabilizers may be provided in the composition, for example, an ultraviolet (UV) light absorber, and/or a visible light absorber and/or a hindered amine light stabilizer for assisting coatings formed by the composition in resisting degradation caused by exposure to sunlight. Light stabilizer can be present in the composition from about 0% to about 10% by weight, or from about 1% to about 7% by weight, or from about 2% to about 4% by weight.

Exemplary light stabilizers include, without limitation, hindered phenols, aromatic amines, organophosphites, thioesters and the like. Specifice examples include, but are not limited to TINUVIN 292 and TINUVIN 1130 both commercially available from Ciba Specialty Chemicals.

The composition also may include a thermal stabilizer for assisting the coatings formed by the composition in resisting degradation caused by exposure to thermal cycling. Thermal stabilizer is can be present in the composition in an amount ranging from about 0% to about 10% by weight, or from about 0.33% to about 2% by weight, or from about 0.66% to about 1.33% by weight. The thermal stabilizer in the composition typically comprises an antioxidant. One suitable example of antioxidant is a phenolic antioxidant such as octadecyl 3,5-di-(tert)-butyl4-hydroxyhydrocinnamate sold under the tradename IRGANOX 1076 and commercially available form Ciba Specialty Chemicals.

One or more fire retardants may also be provided in the composition. Fire retardant can be present in the composition in an amount ranging from about 0% to about 10% by weight, or about 1% to about 7% by weight, or from about 2% to about 4% by weight.

Exemplary fire retardants include, without limitation, powdered or fumed silica, layered silicates, aluminum hydroxide, brominated fire retardants, tris(2-chloroethyl)phosphate, tris(2-chloropropyl)phosphate, tris(2,3-dibromopropyl)phosphate, tris(1,3-dichloropropyl)phosphate, diammonium phosphate, various halogenated aromatic compounds, antimony oxide, alumina trihydrate, polyvinyl chloride, and the like, and combinations thereof.

One or more pigments also may be provided in the composition of the present invention. Pigment can be present in the composition in an amount ranging from about 0% to about 20% by weight, or from about 3% to about 15% by weight, or from about 6% to about 8% by weight. In one embodiment, the composition includes a titanium dioxide pigment such as any of those well-known in the art.

The composition may also include components for controlling static such as about 2% to 5% by weight of a conductive carbon black, or a metal salt, such as a potassium salt (e.g. potassium. hexafluorophosphate), which may be provided in an amount up to about 0.4% by weight of the composition. In an embodiment of the present invention, a potassium salt is dissolved in a propylene glycol with amine functionality and thereafter mixed with the remainder of the amine component.

To prevent sagging of the uncured coating of composition on, for example, a vertical surface, the composition may also include a thixotropic agent (thickener) in an amount of about 0 to 10%, or about 1% to 8%, or about 2% to 4%. The thixotropic agent may also help in preventing the phase separation of pigments and other solids during storage, transportation and application. Examples of thixotropic agents include, without limitation, fumed silica, such as CAB-O-SIL TS-720 and CAB-O-SIL PTG commercially available from Cabot Corp., bentonite clay or the like. The agent may be liquid or solid, or a combination thereof.

The composition may also include other additives such as fillers or even fibrous reinforcement.

The various ingredients of composition may be combined and applied to a substrate according to a variety of combination and application protocols to form protective coatings. Typically, the isocyanate component is maintained separate from the amine component until a short period of time (e.g., less than about 5 minutes, or less than about 60 seconds, or less than about 10 seconds) prior to application of the composition to a substrate. The composition may be applied to a surface of a substrate using suitable art-disclosed techniques, including but not limited to brushing, rolling, dipping, dripping, extruding, curtain coating, swabbing, spraying or the like. Moreover, the composition may be applied continuously or intermittently upon a surface of a substrate.

Nearly any substrate may receive the composition to form a coating thereon. The composition may be applied to metal, plastic, or composite substrates, wood substrates or the like. In preferred embodiments, the composition is applied to coated or uncoated surfaces of metal components such as to painted or electrocoated surfaces of automotive components (e.g., to form a truck bedliner, by coating one or more of the floor, side walls, head board, tail gate or other component of a pick-up truck cargo box) and may be applied in addition to or as a replacement for a clear coat. Depending on the desired texture of the coating, the composition may be applied to achieve a smooth surface, or a roughened or even coarse surface over part or all of the surface.

In certain embodiments, the coated or uncoated surface of a substrate may be treated prior to application of the composition. The surface of a substrate, may be sanded, scuffed, primed or otherwise treated prior to application of the composition to the substrate. For example, it may be desirable to apply a suitable adhesion promoter or primer (such as any of those well-known in the art) to the surface to be coated. Advantageously, such pre-treatment techniques can assist in forming an adherent coating on the surface of the substrate. In one embodiment, the substrate is pre-treated with a plasma, for example, for ionizing oxygen (O2) molecules that are then directed toward the surface of the substrate. In this manner, the plasma treatment forms suitable groups (e.g., ketone or hydroxyl groups) that bond with the composition such that the composition forms a coating that is even more tenaciously adhered to the surface of the substrate. Of course, other suitable surface treatments may be employed as desired. Examples of various potential surface treatments are described in U.S. Pat. No. 5,298,587; U.S. Pat. No. 5,320,875; U.S. Pat. No. 5,433,786; U.S. Pat. No. 5,494,712 U.S. Pat. No. 5,837,958 incorporated herein by reference.

Thus, it will be appreciated that the application of the coating composition of the present invention will result, in certain preferred embodiments, in forming a laminate of a substrate (e.g., metal (such as steel, magnesium, titanium or aluminum), plastic (such as including a polyurethane, a polystyrene, a polyester, polyolefin, a nylon, an epoxy, an acrylic, or the like), a ceramic, a composite, or otherwise), optionally having a layer from a primer or plasma treatment, optionally having one or more coats (e.g., base coat, top coat, clear coat, such as an art-disclosed 2-component urethane or acrylic coating) thereon, and having the coating composition of the present invention thereon.

According to one embodiment, the present invention is directed to a system for combining isocyanate and amine components to form the composition and for applying the composition to a substrate. The system typically includes a supply of isocyanate and a supply of amine-based resin. The system also typically includes a metering system having a first metering container for receiving a predetermined amount of isocyanate and a second metering container for receiving a predetermined amount of resin. Each of these metering containers can be in fluid communication with a nozzle or other application device. Not that the isocyanate and amine components are maintained separately prior to mixing.

In a particular method for applying the composition to a surface, the surface is prepared as desired and provided at a suitable application point. The isocyanate and amine-functional components are delivered to a suitable dispenser. In one embodiment, the components are independently metered to a mixing chamber, where they are mixed, for example, by direct impingement at a controlled ratio, and thereafter released from the dispenser as a mist or fine spray. For example, the isocyanate and amine components can be pumped from their respective supplies to their respective metering containers. Thereafter, the isocyanate and amine components in the containers typically are expelled under pressure from the containers to the nozzle (e.g., which may be part of a gun block) and then are expelled from the nozzle as a spray. The nozzle may include an internal space or cavity wherein the isocyanate component and amine component can intermix, atomize or both such that the resulting spray is a substantially homogeneous composition. The pressure used to expel the spray can be greater than about 1000 psi, or can be between about 1500 psi and 2000 psi.

To apply the composition to a substrate, the substrate may be moved relative to the nozzle, the nozzle may be moved relative to the substrate or a combination thereof such that the spray can be directed at the substrate for layering the composition on the substrate.

It is contemplated that the application system generally described above may be designed as a robotic system. For example, the nozzle, the metering containers or both may be mounted on a robot arm, which may be programmed to move the nozzle as it sprays the composition such that a substrate may be coated as desired. Moreover, such a robotic system could apply coatings upon truck bedliners in an automotive assembly plant or at another location during assembly or formation of a truck. In alternative embodiments, however, the composition may be applied after full assembly of a truck. Advantageously, the composition emits minimal airborne chemicals during application such that spraying systems for applying the composition may be used in a variety of locations.

Although, the composition may be applied at ambient temperature, it may be desirable to heat the isocyanate component, the amine component, or both to no greater than about 90° C. prior to application in order to improve the mixing efficiency, viscosity, flow and wetting properties of the composition during application. Once applied, the composition may be allowed to cure upon the substrate to form a protective coating. Curing may occur at a wide variety of temperatures. Generally, curing occurs at ambient temperature in the absence of applied heat. However, cooling or heating measures may also be taken to lower or raise the temperature of curing.

The rate of curing of the composition may be at least partially chemically controlled, that is, curing of the composition may be controlled by the rate of reaction of the amine component with the isocyanate component. Typically, primary amines react comparatively quickly with the isocyanate, while secondary amines react comparatively slowly. Thus, the amine component may be provided as a mixture of primary and secondary amines that are combined according to weight ratios that are chosen as desired to control the rates of curing of the composition to form the coating. Weight ratios of primary amine to secondary amine appropriate for process of application similar to the one described and shown in FIG. 1 are approximately range from about 0:1 to about 1:1 and can be about 0.2:1, or 0.4:1 or 0.5:1 or 0.8:1 or 1:0.

The composition is well mixed into a substantially homogeneous liquid mixture prior to application to a substrate. Thus, upon curing (which may be accomplished substantially without the need to apply heat to the coating), the composition will form a substantially homogeneous coating. The coating may be applied in one or more layers of one or more continuous or variable thickness. Typical thickness for coatings on automotive components (e.g., for forming a truck bedliner) can range from about 0.5 millimeter to about 20 millimeters, or from about 1 millimeter to about 10 millimeters, or from about 3 millimeters to about 5 millimeters. The thickness may vary across a substrate, randomly or according to a predetermined pattern.

In certain embodiments, the protective coatings formed according to the present invention exhibit various advantageous properties. For example, and without limitation, coatings according to the present invention can exhibit both adhesive and cohesive strength up to and greater than 300 psi when applied to painted and electrocoated surfaces. Additionally, the coating can exhibit superior resistance to degradation caused by UV radiation, moisture, thermal cycles, chemical (e.g., alkali) exposure, salt and the like. Also advantageously, the coating resists fluid spotting such as from liquid soap, windshield solvent, coolant, motor oil, bug and tar remover or the like. Also, the coating can resist color change, dulling, softening or surface distortion from contact with fuel, as well as from contact with acid or alkali substances. Moreover, the coating may desirably exhibit anti-skid properties. Each of the previously discussed properties indicate that the polyurea compositions of the present invention are desirable for use in forming coatings for automotive vehicle components and especially as a truck bed liner. In a particular embodiment, the polyurea composition is employed to form a coating for automotive original equipment, though it may also be provided for after-market application.

Generally, the vehicle is provided and during the vehicle assembly process or otherwise prior to delivery to an end consumer, the vehicle is contacted with the polyurea composition of the present invention. The application of the coating may be done prior to the vehicle painting operation, during the painting operation, or after the painting operation. Application of the coating can be performed at the same facility as the painting of the vehicle. However, it is also possible that it is performed at a remote site. The coating may be applied directly to an untreated or bare surface, to a primed surface, to a surface of a galvannealed steel, to painted surface (e.g., an electrocoat or a color coat, with or without a clear coat, or possibly even to a surface coated by overspray in the painting or other finishing operations of the vehicle).

Of course, the composition may also be employed in other applications by contacting it with a surface of a substrate, such as that found in or on a storage container, shipping container, rail car, waste container, pallet, or the like. It may also be suitably employed for hard surfaces such as panels, doors, flooring, pavement or the like.

It should be understood that the invention is not limited to the exact embodiments or constructions, which have been illustrated and described, but that various changes may be made without departing from the spirit and scope of the invention.

Therefore we claim:

1. A process for coating a surface of an automotive vehicle, comprising:
a) providing a surface of an automotive vehicle;
b) contacting the surface with a composition comprising:
i) an isocyanate in an amount up to about 75% by volume of the composition, the isocyanate being at least 75% aliphatic by weight; and
ii) an amine in an amount up to about 75% by volume of the composition, the amine including between greater than 0% and about 40% by volume of an aliphatic primary amine and between about 40% and about 80% by volume of an aliphatic secondary amine;
wherein the ratio of the isocyanate to the amine within the composition is between 1:3 and 3:1.

2. A process as in claim 1 wherein the isocyanate is present in the composition from about 30% to about 70% by volume and is at least 90% aliphatic by weight.

3. A process as in claim 1 wherein the isocyanate is present in the composition from about 40% to about 60% by volume and is at least 99% aliphatic by weight.

4. A process as in claim 1 wherein the isocyanate component includes less that 1% isocyanate monomer and is selected from the group consisting of dimerized, trimerized and biureted hexamethylene diisocyanate, a prepolymer thereof and mixtures thereof.

5. A process as in claim 1 wherein the amine includes at least 40% of an aspartic acid ester by weight.

6. A process as in claim 1 wherein the amine is maintained separate from the isocyanate until a time that is less than 60 seconds prior to contacting the composition with the substrate.

7. A process as in claim 1 wherein the composition is contacted with the substrate using an apparatus having a first metering container for receiving the amine a second metering container for receiving the isocyanate and a nozzle in fluid communication with the first and second containers for spraying the composition.

8. A process as in claim 1 further comprising adding into the composition a light stabilizer for assisting the coating in resisting degradation due to exposure to light.

9. A process as in claim 1 further comprising adding into the composition an effective amount of a metal salt for controlling static.

10. A process as in claim 1 further comprising adding into the composition a thixotropic agent.

11. A process for coating a surface of an automotive vehicle with a composition, comprising:
a) providing a painted surface of a truck bed;
b) providing at a temperature of no greater than about 90 degree C. an isocyanate component in an amount up to about 75% by volume of the composition, the isocyanate component being at least 75% aliphatic by weight;
c) providing at a temperature of no greater than about 90 degree C. an amine component in an amount up to about 75% by volume of the composition, the amine component including between greater than 0% and about 40% by volume of an aliphatic primary amine and between about 40% and about 80% by volume of an aliphatic secondary amine;
d) intermixing the isocyanate component and the amine component to form an admixture of the components;
e) spraying the admixture onto the truck bed; and
f) curing the admixture at about room temperature;
wherein the ratio of the isocyanate to the amine within the composition is between 1:3 and 3:1.

12. A process as in claim 11 wherein the isocyanate component is present in the composition from about 30% to about 70% by volume and is at least 90% aliphatic by weight.

13. A process as in claim 11 wherein the isocyanate component is present in the composition from about 40% to about 60% by volume and is at least 99% aliphatic by weight.

14. A process as in claim 11 wherein at least a portion of the isocyanate component is selected from the group consisting of dicyclohexylmethane 4,4′-diisocyanate, isophorone diisocyanate, tetramethyl-1,3-xylylene diisocyanate, hexamethylene diisocyanate.

15. A process as in claim 11 wherein the amine component includes at least 65% aspartic acid ester by weight.

16. A process as in claim 11 wherein the amine component is maintained separate from the isocyanate component until no greater than 60 seconds prior to contacting the composition with the substrate.

17. A process as in claim 16 wherein the composition is contacted with the substrate using an apparatus having a first metering container for receiving the amine component, a second metering container for receiving the isocyanate component and a nozzle in fluid communication with the first and second containers for spraying the resulting composition.

18. A process as in claim 11 further comprising adding into the admixture a light stabilizer for assisting the coating in resisting degradation due to exposure to light.

19. A process as in claim 11 further comprising adding into the admixture an effective amount of a potassium salt for controlling static.

20. A process for coating a surface of an automotive vehicle with a composition, comprising:
a) providing a painted surface of a truck bed;
b) providing at a temperature of no greater than about 90 degree C. an isocyanate component in an amount up to about 75% by volume of the composition, the isocyanate component being at least 75% aliphatic by weight;
c) providing at a temperature of no greater than about 90 degree C. an amine component in an amount up to about 75% by volume of the composition, the amine component being at least partially an aspartic ester of polyoxyalkyleneamine having a mole ratio of amine functionality to the ester of no more than 1:1;
d) providing an effective amount of a metal salt for controlling static;
e) providing a thixotropic agent;
f) intermixing the isocyanate component and the amine component, the metal salt and the thixotropic agent to form an admixture of the components wherein the admixture is substantially free of any catalysts;
g) spraying the admixture onto the truck bed; and
h) curing the admixture at about room temperature.

21. A process as in claim 1 wherein the isocyanate has a residual monomer level that is less than about 1% by weight for assisting in lowering any volatile emissions of the composition.

22. A process as in claim 1 wherein the isocyanate has a residual monomer level that is less than about 0.2% by weight for assisting in lowering any volatile emissions of the composition.

23. A process as in claim 11 wherein the isocyanate has a residual monomer level that is less than about 1% by weight for assisting in lowering any volatile emissions of the composition.

24. A process as in claim 11 wherein the isocyanate has a residual monomer level that is less than about 0.2% by weight for assisting in lowering any volatile emissions of the composition.

25. A process as in claim 11, further comprising adding into the admixture a thixotropic agent.

26. A process as in claim 1 further comprising adding into the composition a stannous catalyst wherein the stannous catalyst assists in catalyzing formation of a polyurethane linkage for enhancing bonding of the composition to the surface.

27. A process as in claim 11 further comprising adding into the admixture a stannous catalyst wherein the stannous catalyst assists in catalyzing formation of a polyurethane linkage for enhancing bonding of the composition to the surface.

28. A process as in claim 1 wherein the aliphatic primary amine includes one or more polyoxyalkyleneamines having a molecular weight greater than about 200 for assisting in lowering volatile emissions.

29. A process as in claim 28 wherein the aliphatic secondary amine includes one or more aspartic esters having a molecular weight greater than about 190 for assisting in lowering volatile emissions.

30. A process as in claim 11 wherein the aliphatic primary amine includes one or more polyoxyalkyleneamines having a molecular weight greater than about 200 for assisting in lowering volatile emissions.

31. A process as in claim 30 wherein the aliphatic secondary amine includes one or more aspartic esters having a molecular weight greater than about 190 for assisting in lowering volatile emissions.
